(19) United States
(12) Patent Application Publication
(10) Pub. No.: US 2002/0110786 A1
(43) Pub. Date: Aug. 15, 2002

(54) Method and apparatus for generating a customized dental prosthetic

(76) Inventor: Stephen L. Dillier, Irving, TX (US)

Correspondence Address: Sanford E. Warren, Jr, Gardere Wynne Sewell LLP, 3000 Thanksgiving Tower, Suite 3000, 1601 Elm Street, Dallas, TX, 75201-4767, US

(21) Appl. No.: 09/779,970

(22) Filed: Feb. 9, 2001

(51) Int. Cl. A61C 11/00; A61C 19/00

(52) U.S. Cl. 433/213; 433/34

(57) ABSTRACT

The present invention provides a method of generating a customized dental prosthetic corresponding to the contours of a dental preparation die. In certain embodiments, the method includes fixturing the preparation die into a scanning device and taking measurements of the surface of the die in one or more dimensions. The measurements are used to construct a three-dimensional digital model of the die in a computer's memory. In certain embodiments, a dental prosthetic shape is selected from a library of standard dental prosthetic shapes and aligned with the die model in software. After alignment, the interior surface of the prosthetic model is “morphed” by the software to conform closely to the upper outside surface of the preparation die.

### TECHNICAL FIELD OF THE INVENTION

The present invention relates generally to the manufacture of dental prosthetics including prosthetics, inlays, onlays, and bridges, and more particularly to apparatuses and methods of generating customized dental prosthetics from a library of standard prosthetic shapes.

### BACKGROUND OF THE INVENTION

It is previously known to utilize computer-aided manufacturing of dental and other products usable in the human body. Conventional equipment uses computer-aided equipment in a general manner. Data representing particular alterations and extensions can be attached to a model of a dental preparation die and design measures relating to the die can be taken with the aid of attached input data.

In the case of conventional manual formulation of dental structures such as tooth prosthetics, inlays, onlays, bridges, and the like, a dentist or dental technician prepares a model, which is then dispatched to the manufacturer. When the dentist or dental technician receives the prosthesis from the manufacturer, it is measured for compliance. It is critical that the prosthesis conform closely to the actual shapes of the model, so that the die and prosthetic will form a tight fit. If there is any problem with fit, adjustments are made to the prosthesis. For difficult or complex shapes, this process can take a considerable amount of time.

There is, therefore, a need to obtain and formulate exact prostheses for the practice of the dentist and dental technician. There is also a need for prompt turn-around of the prostheses, a need that is currently not met due to the delays inherent in delivery via mail and couriers. There is, furthermore, a need for a tool or method that can be operated by simple handling principles and routines currently in practice and well known to those of skill in the art of die preparation. Finally, there is a need for an accurate method of creating dental prosthetics having near-perfect fit to the corresponding die.

### SUMMARY OF THE INVENTION

The present invention provides a method of generating dental prosthetics having a superior fit and appearance than prior art dental prosthetics. In certain embodiments, the method of the present invention includes three steps. The first step includes the generation of a set of data points corresponding to the contours of a prepared dentition. The second step includes the selection of a dental prosthetic shape from a library or database of standardized prosthetic shapes. The third step includes the generation of a three-dimensional model having external characteristics derived from the selected standard prosthetic and internal geometry shaped to fit the prepared dentition.

The first step of the method includes fixturing a die representing the shape of a prepared dentition into a scanning device and taking measurements of the surface of the die in one or more dimensions. In one embodiment, this step is used to find the location and shape of one or more contour lines or ridges running along the surface of the die. In certain embodiments, at least one of the contour lines or ridges represents a preparation line on the dental preparation. When implemented using automated equipment, the method may further include the step of visually verifying the accuracy of the contour line approximated by the automated equipment using one or more cameras. The position and orientation of the cameras may in certain embodiments be controlled by the equipment. Other features and advantages of the present invention shall be apparent to those of ordinary skill in the art upon reference to the following detailed description taken in conjunction with the accompanying drawings.

As described above, there is a need to obtain and formulate exact prostheses for the practice of the dentist and dental technician. The present invention addresses this need by providing a tool for highly advanced, on-site prosthesis production or prosthesis copying. The invention solves the problem of shipping delays by storing the datapoints electronically, thereby permitting data to be transmitted to a manufacturer electronically.

The present invention is generally used with computer-aided equipment that is normally a new instrument for currently practicing dentists and dental technicians. The present invention, therefore, is designed to be operated according to simple handling principles and routines currently in practice and well known to those of skill in the art of die preparation.

In order to facilitate accurate human verification of computer-generated preparation lines, certain embodiments of the present invention incorporate closed-circuit cameras continually focused on the surface of the die. In certain embodiments, these cameras are automatically positioned and oriented by the scanning device so as to optimize the viewing angle, and therefore the accuracy, of the verification process.

After measurement and verification of the profile of the die, including the preparation line, the method includes selection of a prosthetic shape to replace and substitute for the original tooth. In certain embodiments, the selection of the prosthetic shape may be performed by a computer using some form of pattern-matching algorithm. In certain embodiments, selection of a prosthetic shape may be performed by a human operator. In certain other embodiments, selection of a prosthetic shape may be performed by a human selecting from a set of prosthetic shapes suggested by a computer.

In certain embodiments, the method includes a process for customizing the selected shape to best conform to the desired appearance and fit within the surrounding teeth. This customization may include, for example, “stretching” or “compressing” the prosthetic shape along one or more axes, “twisting” or “tapering” the prosthetic shape along an axis, or “morphing” the prosthetic shape between selected shapes. Any of these shaping methods may be used in conjunction with any of the other methods, or with any other shaping methods known to those of skill in the art.

The finalized prosthetic shape can then be combined with the profile data for the tooth, including the preparation line data, to generate a full three-dimensional prosthetic model in software. The software model can then be transmitted to a milling machine or similar apparatus to generate a physical prosthetic in any of a variety of materials.

The embodiments of the present invention, therefore, obtain and formulate exact prostheses for the practice of the dentist and dental technician. The present invention also provides prompt turn-around of the prosthetics, a need that is currently not met due to the delays inherent in delivery via mail and couriers. Finally, the apparatus and methods of the present invention can be operated according to simple handling principles and routines currently in practice and well known to those of skill in the art of die preparation. Other features and advantages of the present invention shall be apparent to those of ordinary skill in the art upon reference to the following detailed description taken in conjunction with the accompanying drawings.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 shows a casting of a jaw with teeth and a die taken from this, in perspective section from above;

FIG. 2 shows the embodiment of the die according to FIG. 1 in perspective section from above and in enlarged representation;

FIG. 3 shows an isometric illustration of an apparatus of the present invention;

FIG. 4 shows an enlarged representation of the positioning of a scanning device with the die during the beginning of the method of the present invention;

FIGS. 5A-5C show the various positions of the scanning device during the scanning process to locate a preparation line with the scanning device in a vertical position;

FIGS. 6A-6C show the various positions of the scanning device during the scanning process to locate a preparation line with the scanning device in a horizontal position;

FIG. 7 is a block diagram illustrating the method of scanning the preparation line of the present invention;

FIG. 8 is a block diagram illustrating the method by which the preparation line is initially located;

FIG. 9 is a block diagram illustrating the method by which the preparation line is scanned;

FIG. 10 is a block diagram illustrating the method of verifying datapoints collected during a scan, as in FIG. 9;

FIGS. 11A and 11B show an embodiment of the present invention incorporating a camera to locate a preparation line with the scanning device in a vertical orientation;

FIGS. 12A and 12B show an embodiment of the present invention incorporating a camera to locate a preparation line with the scanning device in a horizontal orientation;

FIG. 13 shows an embodiment of the present invention showing a camera at different positions at different points in time;

FIG. 14 shows an embodiment of the present invention incorporating two cameras to locate a preparation line;

FIG. 15A shows an embodiment of the present invention incorporating a camera and a light source;

FIG. 15B shows an embodiment of the present invention incorporating a camera and a collimated light source;

FIG. 16 shows the camera orientation control mechanism for one embodiment of the present invention;

FIG. 17 shows a flow chart depicting a process for verifying the margin according to certain aspects of one embodiment of the present invention;

FIG. 18A shows a computer display of several views of a digitized preparation die according to one embodiment of the present invention;

FIG. 18B shows a computer display of several views of a digitized preparation die within the patient's existing dentition according to one embodiment of the present invention;

FIG. 18C shows a computer display of several views of a digitized preparation die within the patient's existing dentition according to one embodiment of the present invention;

FIG. 18D shows a computer display of several views of a digitized preparation die within the patient's existing dentition according to one embodiment of the present invention;

FIG. 19 shows a computer display of several digitized prosthetic models according to one embodiment of the present invention;

FIG. 20 shows a computer display of a digitized prosthetic model superimposed on the digitized preparation die of FIG. 18;

FIG. 21 shows a side view of a prosthetic model and die model both before and after alignment of the models;

FIG. 22 shows a side view of a prosthetic model and die model both before and after size adjustment of the prosthetic model;

FIG. 23 shows a side view of a prosthetic model after digital “fitting” to the corresponding die model;

FIG. 24 shows one embodiment of a dial box suitable for use with the methods of the present invention; and

FIG. 25 shows a second embodiment of a dial box suitable for use with the methods of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts.

The present invention provides a method of generating dental prosthetics having a superior fit and appearance than prior art dental prosthetics. In certain embodiments, the method of the present invention includes three steps. The first step includes the generation and verification of a set of data points corresponding to the contours of a prepared dentition. The second step includes the selection of a dental prosthetic shape from a library or database of standardized prosthetic shapes. The third step includes the generation of a three-dimensional model having external characteristics derived from the selected standard prosthetic and internal geometry shaped to fit the prepared dentition.

After measurement and verification of the geometry of the die, the method includes selection of a prosthetic shape to replace and substitute for the original tooth. In certain embodiments, the selection of the prosthetic shape may be performed by a computer using some form of pattern-matching algorithm. In certain embodiments, selection of a prosthetic shape may be performed by a human operator. In certain other embodiments, selection of a prosthetic shape may be performed by a human selecting from a set of prosthetic shapes suggested by a computer.

In certain embodiments, the method includes a process for customizing the selected shape to best conform to the desired appearance and fit within the surrounding teeth. This customization may include, for example, “stretching” or “compressing” the prosthetic shape along one or more axes, “twisting” or “tapering” the prosthetic shape along an axis, or “morphing” the prosthetic shape between selected shapes. Any of these shaping methods may be used in conjunction with any of the other methods, or with any other shaping methods known to those of skill in the art.

Before a prosthetic model can be generated, a casting must be taken of the patient's existing dental structure. Referring to FIG. 1, a conventional casting of a human jaw is indicated by 2. From the casting 2, a preparation model or die 4 can be extracted using any known manner of preparation. The die 4 is disposed on a holding part 6. Secured to the holding part 6 may be pegs 8. The pegs 8 can be used to secure the die 4 in a holder. The casting 2 can be made in plastic, plaster, and like, which are commonly known to those of skill in art.

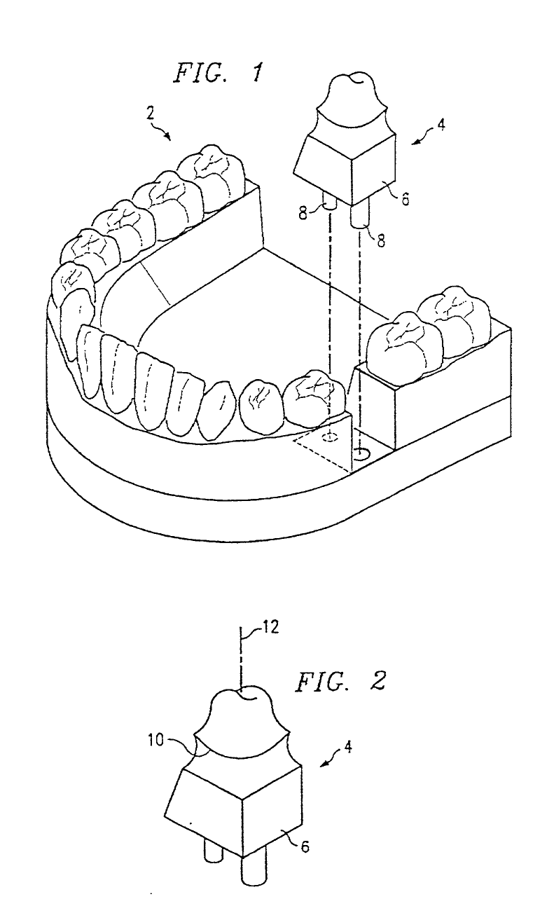

FIG. 2 shows an enlarged view of the die 4. Once again, the die 4 is shown being fixed to a holding part 6. The die 4 exhibits a marked preparation line 10. A center axis 12 is also shown running through the middle of the die 4. The center axis 12 is used to align the die with during the scanning process. The preparation line 10 runs around a circumference of the die and indicates that area to which the restoration meets remaining natural dentition.

Referring to FIG. 3, an apparatus of the present invention is shown. The apparatus includes one or more motion controllers. As shown in FIG. 3, a first horizontal motion controller 305 is slidably connected to a vertical motion controller 300. The first horizontal motion controller 305 can move vertically along the vertical motion controller 300. This motion would correspond to the Z-axis in the Cartesian coordinate system. A holder 315 containing a die 320 can be slidably mounted to the first horizontal motion controller 305. Such mounting enables the holder to be moved horizontally, side-to-side, along the X-axis of the Cartesian coordinate system.

The holder 315 can be made of any numerous materials, such as metal, plastic, wood, and the like. The holder 315 may contain a plastic or rubber insert for securing the pegs of the die 320. Similarly, the holder 315 can be any shape. The holder 315 can be designed to receive and secure a single die or several dies. The holder 315 can also include a clamp to grasp the holding part of the die 320. In the clamp configuration of the holder 315, the die 320, may be used with or without pegs. The clamp can be designed to grasp either the pegs or the holding part. The holder 315 also includes a rotatable peg at the base of the holder. The rotatable peg allows a technician or user to align the die with a scanning device. The holder 315 is aligned using any conventional method. Once the holder 315 is aligned, the base position is fixed such that the die will remain in its aligned position.

A second horizontal motion controller 310 is mounted to the vertical motion controller 300. Slidably attached to the second horizontal motion controller 310 is a scanning device 325. The scanning device 325 can move along the second horizontal motion controller 310 in a horizontal motion along the Y-axis of the Cartesian coordinate system. The scanning device 325 can be any type of scanner, such as a touch trigger probe, a triangulating laser, a strained gauge, and the like. For the touch trigger probe, the scanner can be a single cylinder, a cylinder with a hemisphere end, or a cylinder with a sensing ball on the end. It is preferred to use a touch trigger probe with a sensing ball end. In this configuration, the ball is typically wider than the cylinder or shaft to which it connects. In a normal configuration, the shaft is about 200 microns smaller in diameter than the ball. By providing a smaller shaft, the sensing device can avoid accidental impacts between the side of sensing device and the surface of the die, which may occur from tilting of the sensing device. For a typical touch trigger probe used with present invention, the sensing ball should be between about 0.3 mm to about 3 mm in diameter. In a preferred embodiment, the ball should be between about 0.6 m to about0.8 mm.

It should be appreciated that although an apparatus for which both the scanning device 325 and the holder 315 move in a coordinated motion along one or more Cartesian planes, an apparatus can be constructed whereby the holder 315 remains stationary and the scanning device 325 moves in the X, Y, and Z directions. This can be accomplished by slidably mounting the first horizontal motion controller 305 to the second horizontal motion controller 310, and slidably mounting the second horizontal motion controller 310 to the vertical motion controller 300, thereby allowing the scanning device to move in all three Cartesian coordinates, namely X, Y, and Z directions. Additionally, it should be appreciated that the apparatus can be constructed such that the holder 315 can be moved in a similar manner as the scanning device just described, while the scanning device 325 remains stationary.

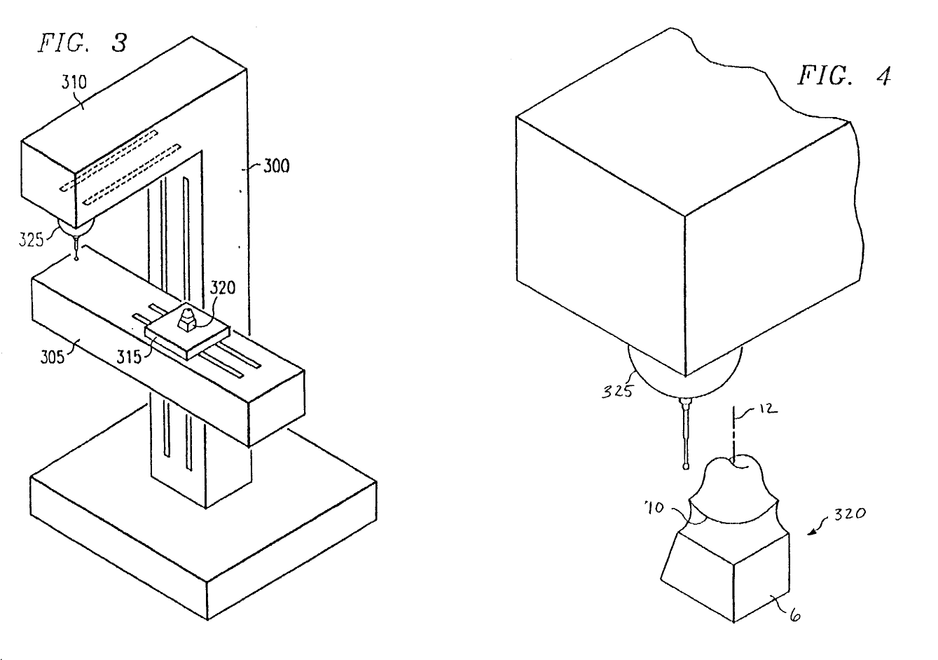

FIG. 4 shows an enlarged view of the die 320 aligned with the scanning device 325. The initial alignment allows the scanning device 325 to be positioned above the die 320. In this initial position, the scanning device 325 may not be in contact with the surface of the die 320. The scanning device 325 and the center axis 12 of the die 320 can be aligned in parallel. It should be appreciated, however, that the scanning device 325 and the die 320 can be perpendicular to each other such that the scanning device 325 and the center axis 12 form a 90 degree angle with each other.

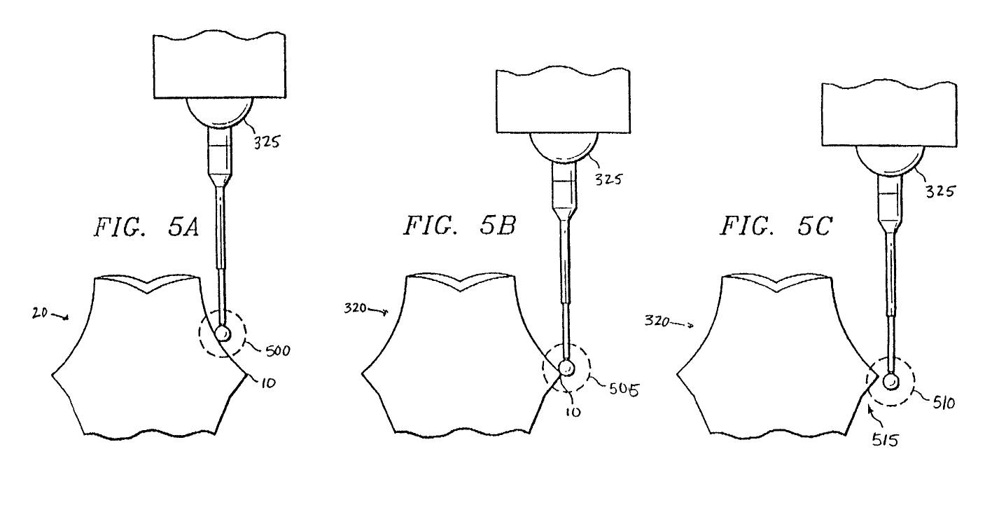

Once scanning begins, as shown by FIG. 5a, the scanning device 325 contacts the surface at a point 500. The scanning device may continuously move along the surface of the die 320 until it reaches the preparation line 10. FIG. 5b shows the scanning device 325 contacting the preparation line at a point 505. FIG. 5c shows the scanning device 325 reaching a fall off point 510. This fall off point is known as the ditch 515. As the scanning device 325 contacts the surface of the die 320, the scanning device 325 collects a data point. From this data point, the scanning device 325 determines the approximate location of the next location to be scanned. The scanning device 325 then moves to the next location and attempts to contact the surface of the die 320. The movement of the scanning device 325 along the surface of the die 320 may in certain embodiments be about 20 microns. Once the scanning device 325 reaches the fall off point 510 as in FIG. 5C, the scanning device records the previously collected datapoint as the location of the preparation line.

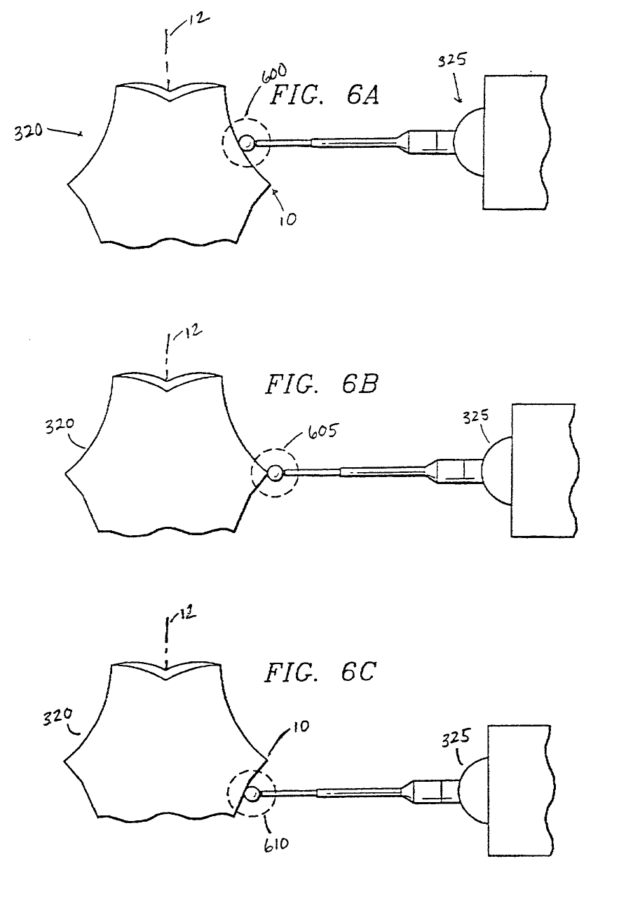

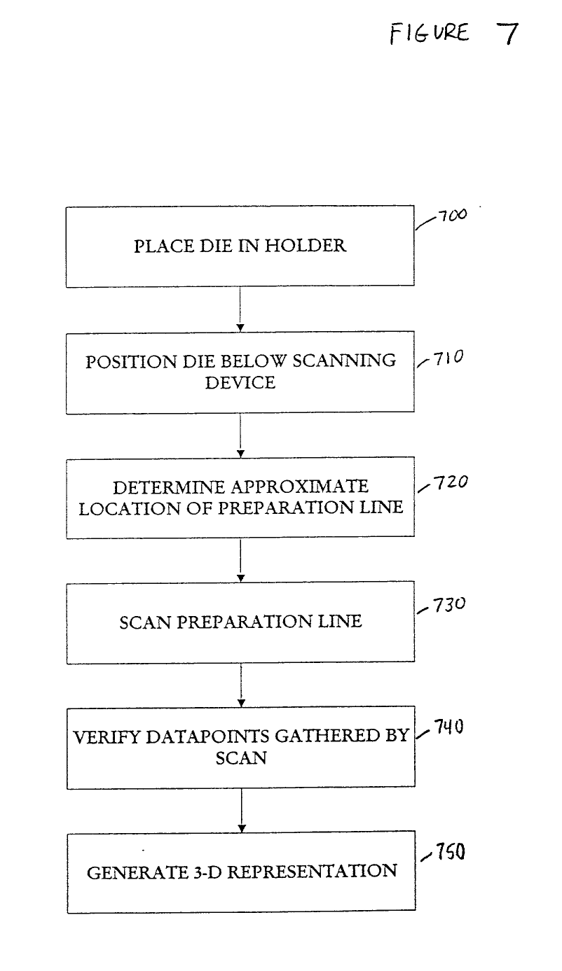

Another application of the present invention is shown in FIG. 6A-6C. In FIGS. 6A-6C, the scanning device 325 is positioned perpendicular to the center axis of the die 320. Similar to FIGS. 5A-5C, the scanning device 325 initially contacts the surface of the 320 at a point 600. The scanning device 325 collects the data point and then determines the next location to be scanned. The scanning device then moves down the slope of the die 320 until it reaches the preparation as shown by point 605 in FIG. 6B. During the next movement of the scanning device 325, the scanning device 325 makes contact with a point 610 closer to the center axis than the point 605. The scanning device related this occurrence to the discovery of the preparation line and records datapoint 605 of FIG. 6B as corresponding to the preparation line.

The process of scanning a die using the present invention is more fully shown by FIG. 7. Initially, the die, after being cast, is placed in a holder, as shown by block 700. After the die is placed in the holder, the die can be positioned below the scanning device, as shown by block 710. This alignment can be accomplished by moving the holder and the scanning device in a coordinated motion along the Cartesian planes. The scanning device then determines the approximate location of the preparation line, as in block 720. This determination can be made using the method described with FIGS. 5a through 5c or 6A through 6C, namely stepping down the surface of the die. After the scanning device has determined the location of the preparation line, the scanning device then moves around a circumference of the die scanning each point which it believes corresponds to a point along the preparation line, shown by block 730. Once the scanning device has collected all of the data points corresponding the preparation line, those data points may be verified by the user or technician operating the device, as shown by block 740. After the data points are verified by the user, a computer aided three-dimensional representation of the actual preparation line of the die can by created, as shown by block 750.

It should be appreciated that more than one dies can be scanned at a time using the method described in FIG. 6. It should also be appreciated that multiple scanning devices can be used to perform the scan of the die. By increasing the number of scanning devices, the scan time can be reduced.

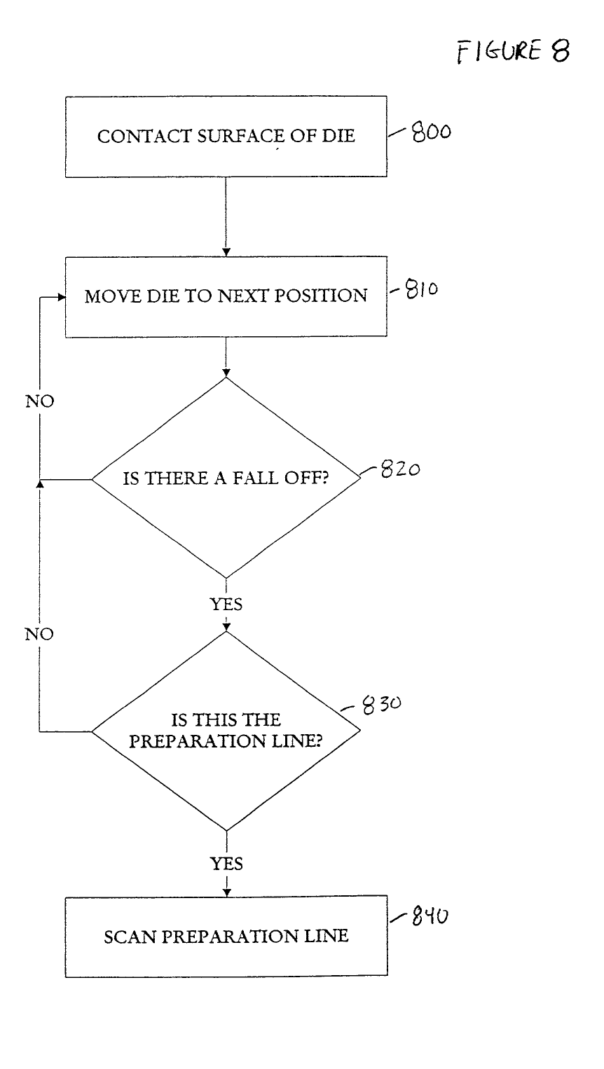

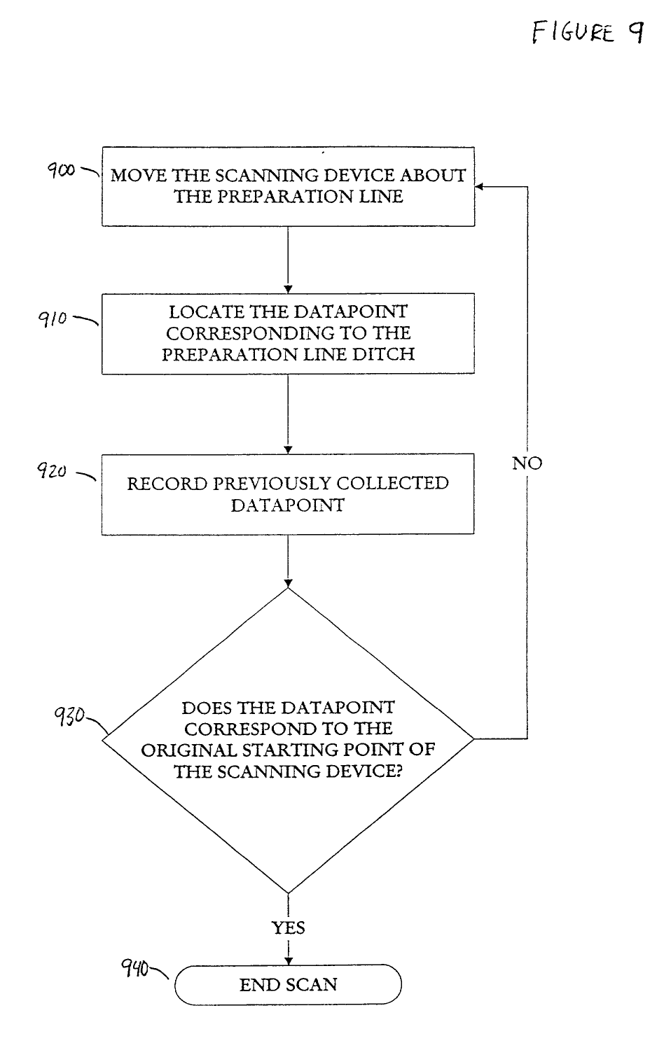

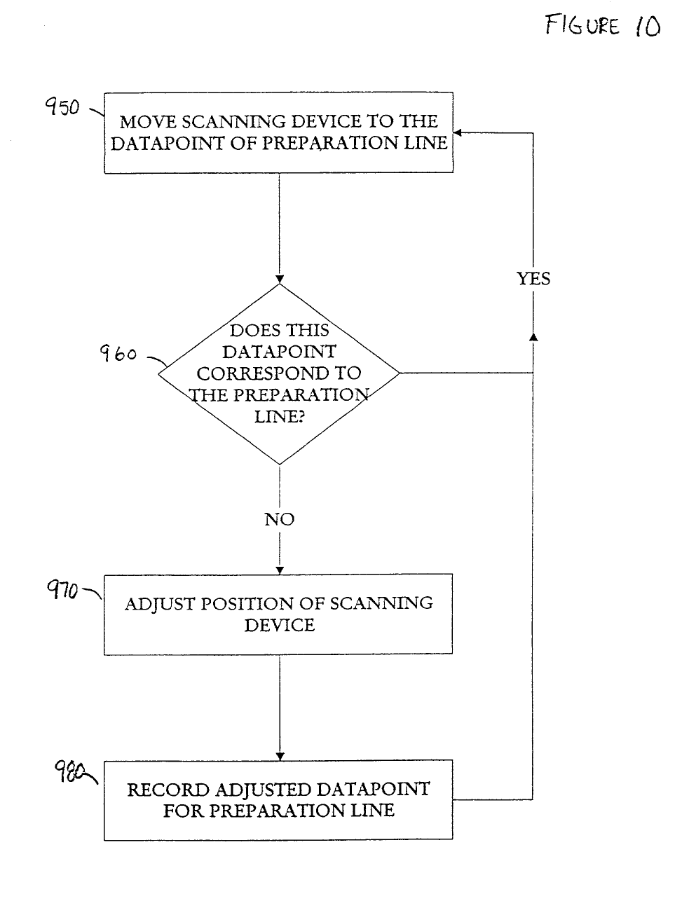

Referring now to FIG. 8, a more detailed explanation of the determination of the location of the preparation line is provided. Initially, the scanning device contacts the surface of the die, as shown by block 800. The initial contact datapoint can be collected by the scanning device. After the collection of the datapoint, the scanning device can be moved along the surface of die, as in block 810. This movement may be controlled by predication and approximations made by the scanning device of the next location to be scanned on the die. At this time, as shown by block 820, the scanning device determines if it has reached a fall off point. If the scanning device has not reached a fall off point, then the scanning device can be moved to another position along the surface of the die. If, however, a fall off point has been reached, then the user may be asked if the fall off point corresponds to the preparation line, as shown by block 830. If fall off point does not correspond to the preparation line, then the scanning device may be moved to the position along the surface of the die. If, however, the fall off point corresponds to the preparation line, the scanning device records the data point corresponding to the last position of the die contact by the scanning device before the scanning device reached the fall off point, as shown by block 840. The scanning device can use the position of the preparation line to scan the preparation around the circumference of the die.

Referring now to FIG. 9, the method by which the preparation line is scanned is shown. In a step 900, the scanning device may be moved about the preparation line. As the scanning device is moved, it contacts the surface of the die at a position above the approximate location of the preparation line. The scanning device then moves towards the preparation line until it reaches a fall off point as shown by FIGS. 5A through 5C and 6A through 6C, as shown in block 910. This point corresponds to the ditch. Once the scanning device reaches a fall off point, the datapoint collected immediately before the fall off point is recorded, as shown by block 920. This datapoint is the datapoint corresponding to the preparation line. In certain embodiments, the movement between locations along the preparation line may be between 20 microns to about 200 microns. One embodiment of the present invention moves the scanning device in approximately 100 micron increments around the preparation line. After the collection of each datapoint, the scanning device determines if the datapoint recorded is less than the distance between each scan point and the initial starting point for the scan, as shown by block 930. If the datapoint is not within the range, then the scanning device can be moved to another position and another scan may be performed. If, however, the datapoint is within this range, then the scan may be ended. For example, if the scanning device moved in 100 microns increments around the preparation line and a datapoint was collected that was 80 microns from the initial starting point, then the scanning would end.

Once the scan ends, the datapoints collected by the scanning device may be verified for accuracy, as shown by FIG. 10. After the scanning device has collected all the datapoints corresponding to the approximate location of the preparation line, as shown by block 950, the scanning device may be moved to a position corresponding to a datapoint along the preparation line. The user then verifies that the datapoint occurs along the actual preparation line, as shown by block 960.

If the scanned datapoint corresponds to the actual preparation line, then the scanning device may be moved to another scanned datapoint in the sequence of scanned datapoints collected by the scanning device. If, however, the scanned datapoint does not correspond to the actual preparation line, then the user may adjust the position of the scanning device to a position which corresponds to the actual preparation line, as shown in block 970. Once the user has adjusted the location of the scanning device, the adjusted datapoint then replaces the scanned datapoint, as shown in block 980.

In addition to adjusting individual datapoints, a region of datapoints may be adjusted simultaneously. The technician or user places the scanning device at the beginning point of a region of data points that do not correspond to the actual preparation line. The technician then repositions the scanning device on the preparation line and the new adjusted datapoint for the beginning of the region may be recorded. Next, the technician moves the scanning device to the datapoint at the end of the region to be adjusted and adjusts the datapoint to a position on the actual preparation line. The adjusted datapoint at the end of the region may then be recorded. Once the adjusted datapoints for the beginning and end of the region are collected, a computer aided design program then extrapolates the position of the datapoints in between the beginning datapoint and the end datapoint of the region to be adjusted.

The computer aided design program may reside in one or more computers. The computer may be connected to the scanning devices. Once the scanning device has collected all the datapoints, and after the datapoints are verified as corresponding to the preparation line, the computer aided design program takes the datapoints and creates a three-dimensional representation of the preparation line of the die.

In summary, the present invention may be used by those of skill in the art to practice their trade without the need to resort to new, expensive equipment. It provides a time-saving device that permits the use of known dentist/dental technician skills and may be used in connection with the formulation of tooth sleeves, dental bridges, and the like present. The invention largely solves this problem and permits routines in which repeated dealings with the product are eliminated. The dentist/dental technician may further modify the shape in the copying process, as well as when checking patient-matching. The dentist/dental technician may also optimally use available spaces for cement and modifications. Furthermore, accurate adjustments may be made to the interface between the sleeve/bridge and tooth remnants, jawbone, and the like.

In connection with computer-aided copying of a dental product, the present invention provides for the identification of the actual preparation line on the actual die, not a computer representation. The invention solves this problem and offers aids to enable the dentist/dental technician to fix the preparation line for the output data with great accuracy on the actual die.

In the formulation of models and products, e.g., tooth sleeves, it is necessary that the angling of the sleeve material at the preparation line be exact. The angling is based upon the actual position on the tooth of the preparation line and is obtained on the actual die in real time by the operator using his or her known skills.

Shapes of the teeth also vary within broad limits. Special characteristic features may be approximated by the dental technician/dentist using the actual die by tracing the different basic forms, namely eye-tooth, front tooth, milk tooth, and the like. Teeth, models, and the like are largely individual and scanning of three-dimensional bodies of this type normally requires large data quantities to be handled.

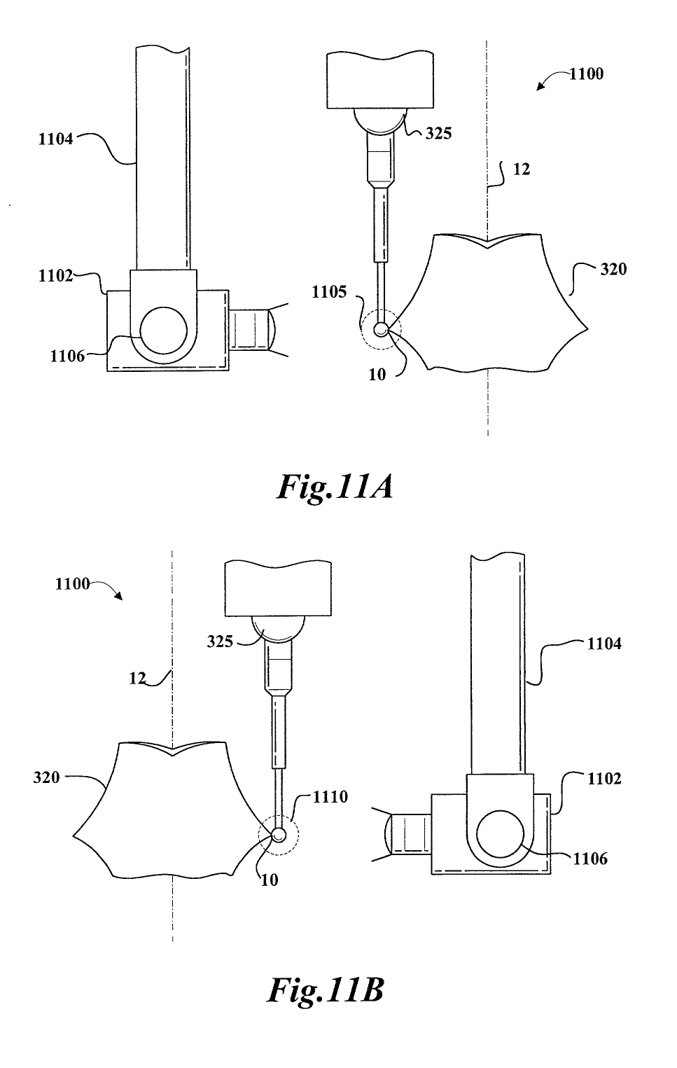

In order to facilitate greater accuracy during the process of verification of the proper location of the preparation line, certain embodiments of the present invention incorporate one or more cameras to assist the user. Various aspects of these embodiments are shown in detail in FIGS. 11a-16 and described below. It should be noted at the outset that although the following description pertains to a process in which verification of the position of the preparation line performed on the same apparatus as used for the scanning process, nothing within the nature of the invention requires that verification be performed on the same apparatus.

FIGS. 11a and 11b show an embodiment 1100 of the present invention incorporating a camera 1102 in a substantially horizontal orientation to verify a preparation line 10 with the scanning device 325. Once verification begins, as shown by FIG. 11a, the scanning device 325 contacts the surface at a point 1105. The scanning device 325 moves from point to point along the surface of the die 320 along the device's best estimation of the preparation line 10. The location of the scanning device 325 on the surface of the die 320 is at each point monitored and verified, and if necessary adjusted, by the user via the camera 1102.

In the embodiment shown in FIGS. 11a and 11b, the camera 1102 is positioned and oriented by the scanning device 325 using the positioning structure 1104 having one or more joints, such as joint 1106, designed to optimally position and orient camera 1102. The position and orientation of the camera 1102 is in certain embodiments continuously updated by the scanning device 325 so as to maintain a fixed relationship to the surface of the die 320 as the scanning device 325 moves around the preparation line 10 of the die 320. For example, certain embodiments of the present invention may continuously update the position and orientation of the camera 1102 so as to continuously align the central axis of the camera 1102 with the vector normal to the surface of the die 320. Certain embodiments may incorporate a certain degree of remote user control over the position and orientation of camera 1102 in addition to automated positional control.

FIG. 11b shows the scanning device 325 contacting the preparation line at a point 1110 on the opposite side of the die 320 from point 1105. It can be seen in FIG. 11b that the scanning device 325 has moved and reoriented the camera 1102 so that the camera 1102 continues to point at the outside surface of the die 320. Both FIGS. 11a and 11b show the camera in a substantially horizontal orientation, but the optimal orientation will vary with the particular application.

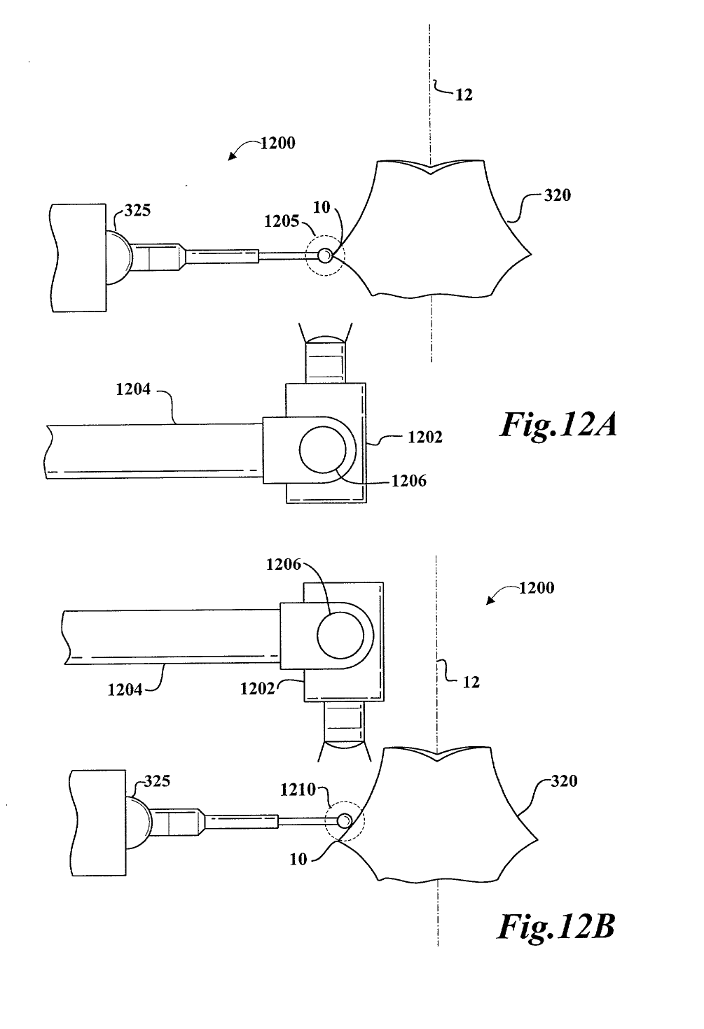

FIGS. 12a and 12b show an embodiment 1200 of the present invention incorporating a camera 1202 in a substantially vertical orientation to verify a preparation line 10 with the scanning device 325. Once verification begins, as shown by FIG. 12a, the scanning device 325 contacts the surface at a point 1205. The scanning device 325 moves from point to point along the surface of the die 320 along the device's best estimation of the preparation line 10. The location of the scanning device 325 on the surface of the die 320 is continuously monitored and verified, and if necessary adjusted, by the user via the camera 1202.

In the embodiments shown in FIGS. 12a and 12b, the camera 1202 is positioned and oriented by the scanning device 325 using the positioning structure 1204 having one or more joints, such as joint 1206, designed to optimally position and orient camera 1202. The position and orientation of the camera 1202 is in certain embodiments continuously updated by the scanning device 325 so as to maintain a fixed relationship to the surface of the die 320 as the scanning device 325 moves around the preparation line 10 of the die 320. For example, certain embodiments of the present invention may continuously update the position and orientation of the camera 1202 so as to continuously align the central axis of the camera 1202 with a vector normal to, or parallel to, the surface of the die 320. Certain embodiments may incorporate a certain degree of remote user control over the position and orientation of camera 1202 in addition to automated positional control.

FIG. 12b shows the scanning device 325 contacting the surface of the die 320 at a point 1210 above the preparation line 10. It can be seen in FIG. 12b that the scanning device 325 has moved and reoriented the camera 1202 so that the camera 1102 continues to have a clear view of the contact point 1210 between the scanning device 325 and the surface of the die 320. Both FIGS. 12a and 12b show the camera in a substantially vertical orientation, but the optimal orientation will vary with the particular application.

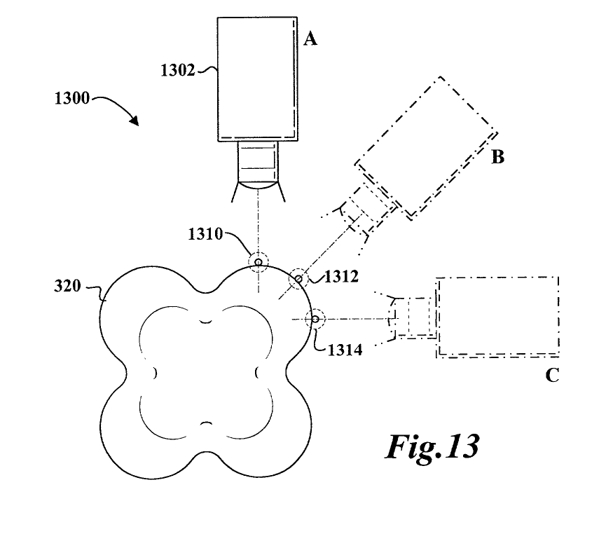

FIG. 13 shows an embodiment 1300 of the present invention showing the camera 1302 in a variety of positions at various times. Camera 1302 is used to verify a preparation line 10 with the scanning device 325. The scanning device 325 moves along the surface of the die 320 through a series of points such as points 1310, 1312, and 1314 along the device's best estimation of the preparation line 10. At each point in time, the scanning device 325 orients the camera 1302 in an orientation to maximize the viewability of the preparation line. The location of the scanning device 325 on the surface of the die 320 is at each point monitored, verified, and adjusted by the user via camera 1302. At one time shown in FIG. 13, the scanning device 325 contacts the surface at a point 1310. With the scanning device 325 in this position relative to the die 320, the scanning device 325 is programmed to place the camera 1302 at position A so as to maximize viewability. At subsequent times, when the device is at other points along the preparation line, such as points 1312 and 1314, the device 325 will reposition the camera 1302 to maintain an optimum viewing location and orientation for each point. Examples of such positions include position B and position C.

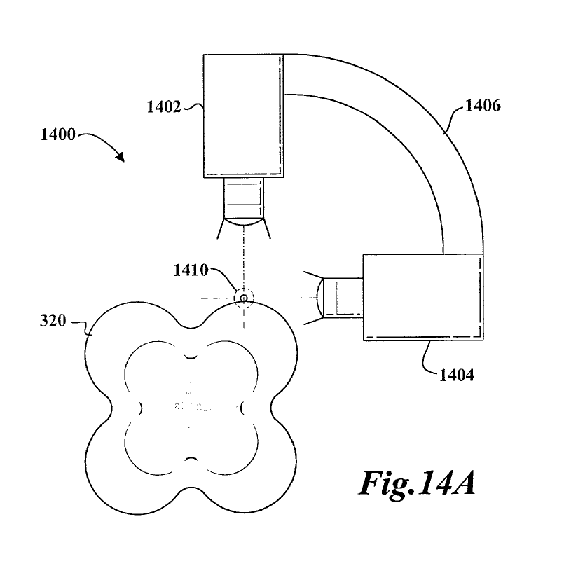

FIG. 14 shows an embodiment 1400 of the present invention incorporating two cameras 1402 and 1404 to locate a preparation line 10 with the scanning device 325. The scanning device 325 contacts the surface at a point 1410. The scanning device 325 moves along the surface of the die 320 along the device's best estimation of the preparation line 10. The location of the scanning device 325 on the surface of the die 320 is at each point monitored, verified, and adjusted by the user via cameras 1402 and 1404.

In the embodiment shown in FIG. 14, cameras 1402 and 1404 are positioned and oriented by the scanning device 325 using a positioning structure 1406 designed to optimally position and orient cameras 1402 and 1404. The position and orientation of the cameras 1402 and 1404 are in certain embodiments continuously updated by the scanning device 325 so as to maintain a fixed relationship between cameras 1402 and 1404 and the surface of the die 320 as the scanning device 325 moves around the preparation line 10 of the die 320. For example, certain embodiments of the present invention may continuously update the position and orientation of cameras 1402 and 1404 so as to continuously align the central axis of camera 1402 with the vector normal to the surface of the die 320 while at the same time continuously aligning the central axis of camera 1404 with a vector tangent to the surface, as shown in FIG. 14. Certain embodiments may incorporate a certain degree of remote user control over the position and orientation of cameras 1402 and 1404 in addition to automated positional control.

FIG. 14 shows cameras 1402 and 1404 having a fixed orientation to one another and having a substantially horizontal orientation, but the optimal orientation of cameras 1402 and 1404 will vary with the particular application. Although cameras 1402 and 1404 are shown at approximately 90 degrees to one another, nothing within the nature of the present invention limits the cameras to such a relationship. For example, either or both of cameras 1402 and 1404 could be oriented at a 45 degree angle to the surface of the die 320. Additionally, certain embodiments of the present invention may incorporate three or more cameras, with any one or more of the cameras being articulated by the scanning device 325, without departing from the spirit and scope of the present invention.

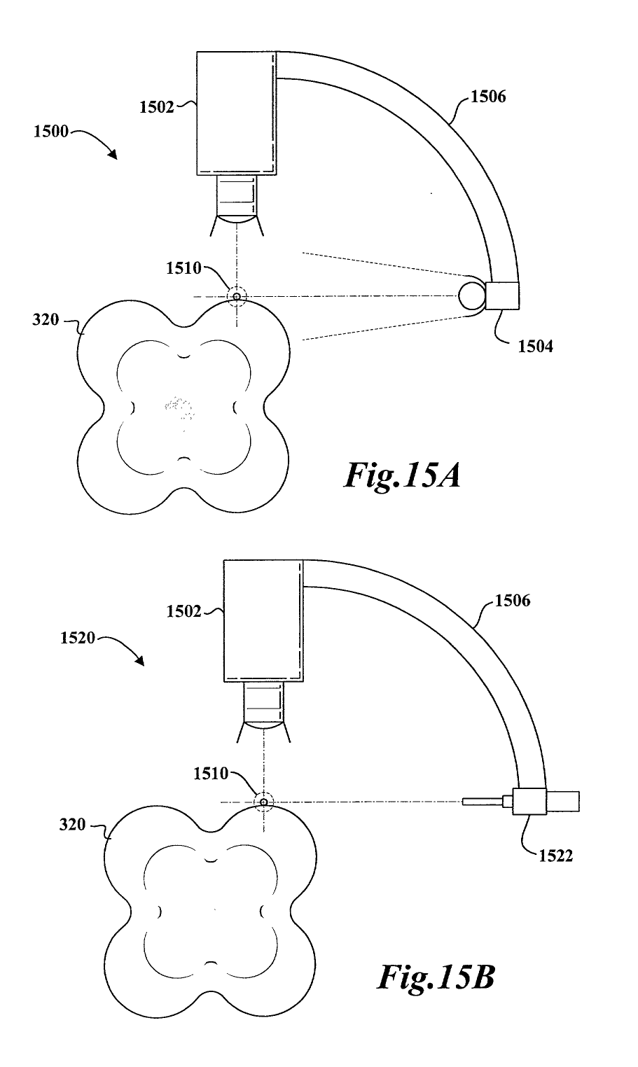

FIG. 15A shows an embodiment 1500 of the present invention incorporating a camera 1502 and a light source 1504 to locate a preparation line 10 with the scanning device 325. The scanning device 325 contacts the surface at a point 1510. The scanning device 325 may continuously move along the surface of the die 320 along the device's best estimation of the preparation line 10. The location of the scanning device 325 on the surface of the die 320 is continuously monitored by the user via camera 1502 and light source 1504.

In the embodiment shown in FIG. 15A, the camera 1502 is positioned and oriented by the scanning device 325 using a positioning structure 1506 designed to optimally position and orient camera 1502 and light source 1504. The position and orientation of camera 1502 and light source 1504 are in certain embodiments continuously updated by the scanning device 325 so as to maintain a fixed relationship between the camera 1502 and light source 1504 and the surface of the die 320 as the scanning device 325 moves around the preparation line 10 of the die 320.

Certain embodiments of the present invention may continuously update the position and orientation of camera 1502 and light source 1504 so as to continuously align the central axis of camera 1502 with the vector normal to the surface of the die 320 while at the same time continuously aligning the central axis of light source 1504 with a vector tangent to the surface, as shown in FIG. 15A. Certain embodiments may incorporate a certain degree of remote user control over the position and orientation of camera 1502 and light source 1504 in addition to automated positional control. The user may also, in certain embodiments, be given control over the intensity, color, polarization, or other attribute of the light emitted by light source 1504.

FIG. 15A shows camera 1502 and light source 1504 having a fixed orientation to one another and having a substantially horizontal orientation, but the optimal orientation of camera 1502 and light source 1504 will vary with the particular application. Although camera 1502 and light source 1504 are shown at approximately 90 degrees to one another in FIG. 15A, nothing within the nature of the present invention limits the camera 1502 and light source 1504 to such a relationship. For example, either or both of camera 1502 and light source 1504 could be oriented at a 45-degree angle to the surface of the die 320. Additionally, certain embodiments of the present invention may incorporate multiple cameras and light sources, with any one or more of the cameras or light sources being articulated by the scanning device 325, without departing from the spirit and scope of the present invention.

FIG. 15B shows an embodiment 1520 of the present invention incorporating a camera 1502 and a collimated light source 1522 to locate a preparation line 10 with the scanning device 325. The scanning device 325 contacts the surface at a point 1510. The scanning device 325 may continuously move along the surface of the die 320 along the device's best estimation of the preparation line 10. The location of the scanning device 325 on the surface of the die 320 is continuously monitored by the user via camera 1502 and light source 1522. In contrast to the diffuse light source 1504 shown in FIG. 15A, the collimated light source 1522 of FIG. 15B is designed to focus and pinpoint light on a particular point on the die 320.

In the embodiment shown in FIG. 15B, the camera 1502 and light source 1522 are positioned and oriented by the scanning device 325 using a positioning structure 1506 designed to optimally position and orient camera 1502 and light source 1522. The position and orientation of camera 1502 and light source 1522 are in certain embodiments continuously updated by the scanning device 325 so as to maintain a fixed relationship between the camera 1502 and light source 1522 and the surface of the die 320 as the scanning device 325 moves around the preparation line 10 of the die 320. For example, certain embodiments of the present invention may continuously update the position and orientation of camera 1502 and light source 1522 so as to continuously align the central axis of camera 1502 with the vector normal to the surface of the die 320 while at the same time continuously aligning the central axis of light source 1522 with a vector tangent to the surface, as shown in FIG. 15B. Certain embodiments may incorporate a certain degree of remote user control over the position and orientation of camera 1502 and light source 1522 in addition to automated positional control. Certain embodiments may incorporate one or more scanning mirrors between light source 1522 and die 320, to allow for illumination of a line or pattern on die 320.

FIG. 15B shows camera 1502 and light source 1522 having a fixed orientation to one another and having a substantially horizontal orientation, but the optimal orientation of camera 1502 and light source 1522 will vary with the particular application. Although camera 1502 and light source 1522 are shown at approximately 90 degrees to one another in FIG. 15B, nothing within the nature of the present invention limits the camera 1502 and light source 1522 to such a relationship. For example, either or both of camera 1502 and light source 1522 could be oriented at a 45 degree angle to the surface of the die 320. Additionally, certain embodiments of the present invention may incorporate multiple cameras, diffuse light sources, and collimated light sources, with any one or more of the cameras or light sources being articulated by the scanning device 325, without departing from the spirit and scope of the present invention.

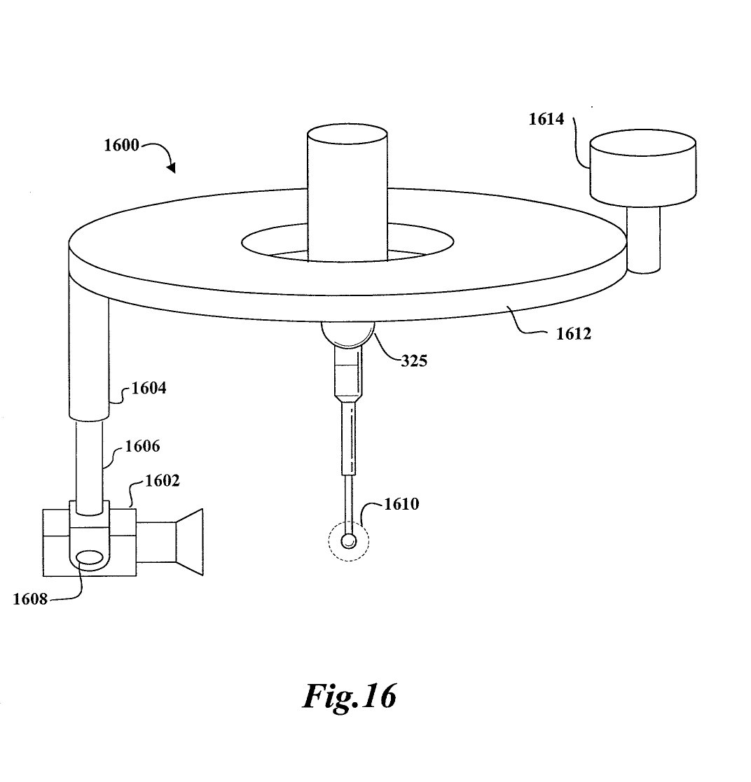

FIG. 16 shows the camera orientation control mechanism 1600 for one embodiment of the present invention. In this embodiment, camera 1602 is mounted on a support column including first support 1604, second support 1606, and pivot joint 1608. As shown in FIG. 16, these structures hold camera 1602 in an orientation allowing a clear view of point 1610 at the end of scanning device 325. In various embodiments of the present invention, the position of camera 1602 may be adjustable by extension and retraction of column 1606, by rotation of column 1606, or by rotation around joint 1608. Other embodiments may incorporate more or fewer degrees of freedom as various applications necessitate.

In the embodiment shown in FIG. 16, camera 1602 is positioned around point 1610 by rotary element 1612 acting under the control of motor 1614. Motor 1614 may be, in various embodiments, a stepper motor, a servo motor, or a simple brushed DC motor acting under the control of the user. In various embodiments, motor 1614 may interface with element 1612 via mating gear teeth, a positive drive timing belt, a chain and sprocket mechanism, a friction drive, or any of a number of mechanisms known in the art of power transmission. Certain embodiments may incorporate additional articulated cameras or lights, either attached to rotary element 1612, or positioned by a separate positioning mechanism.

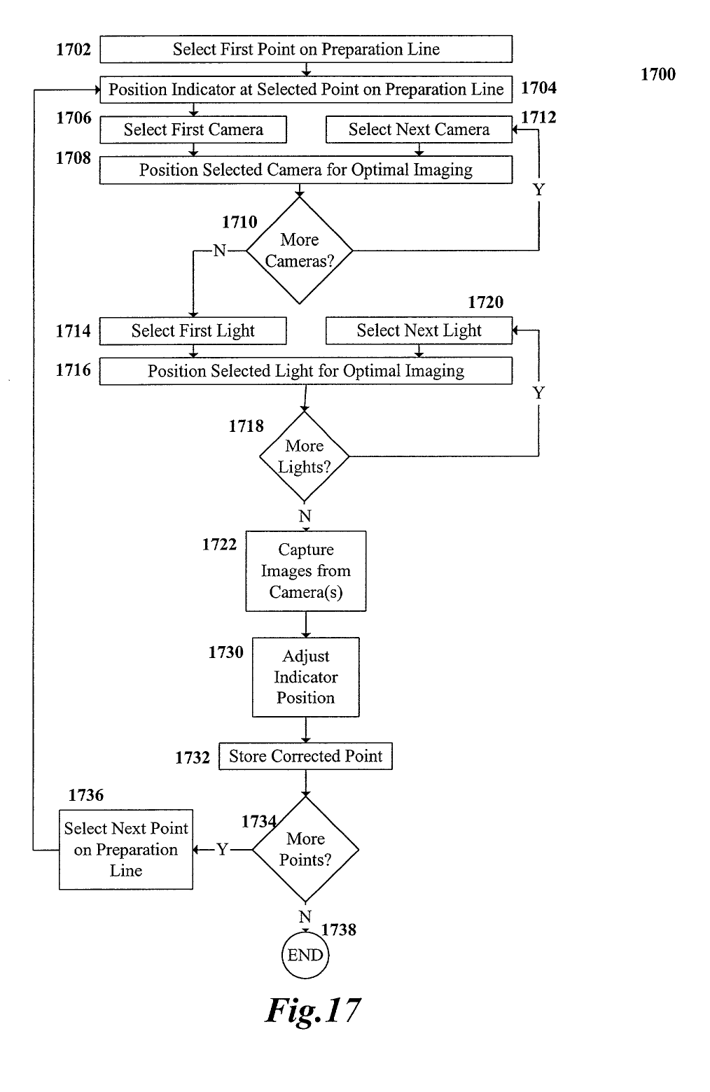

FIG. 17 is a flow chart, generally designated 1700, graphically depicting the flow of one embodiment of the process of the present invention. As can be seen in FIG. 17, process flow begins in block 1702. As seen in blocks 1704-1736 of FIG. 17, the system uses each of the one or more viewing cameras (1706-1712) and one or more lights (1714-1720) in the device to view (1722) and adjust (1730) each of the points along the preparation line in the model.

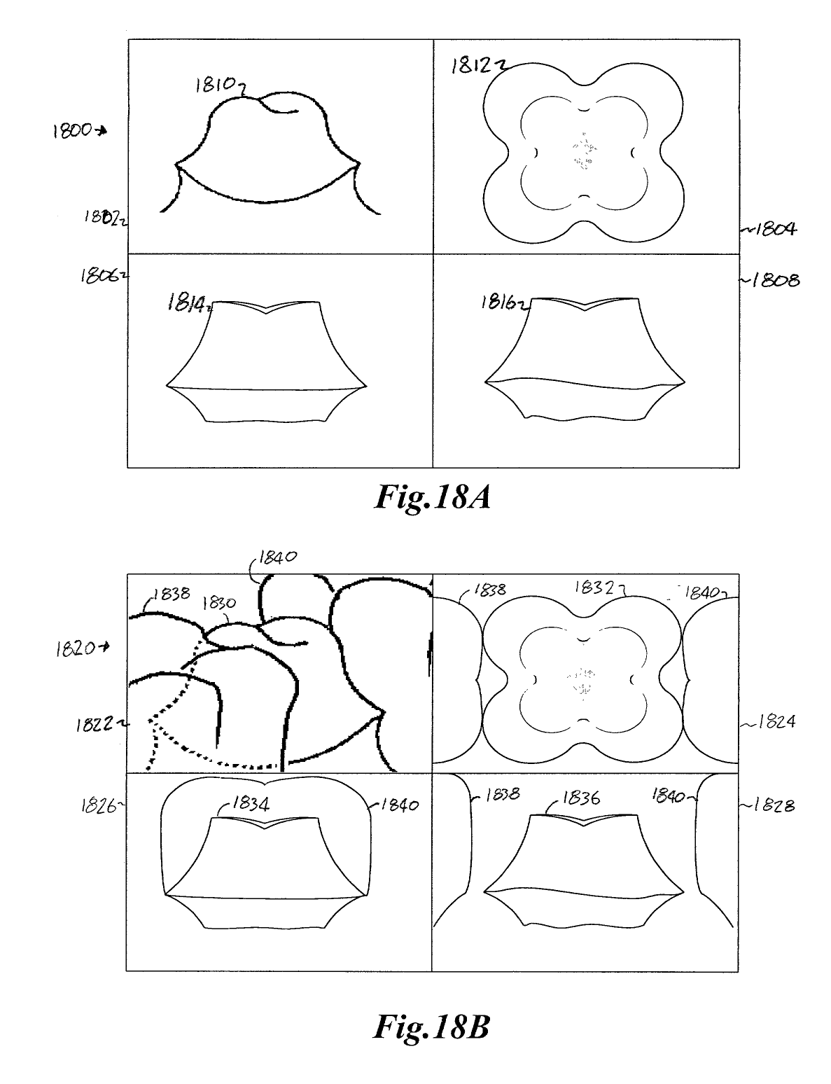

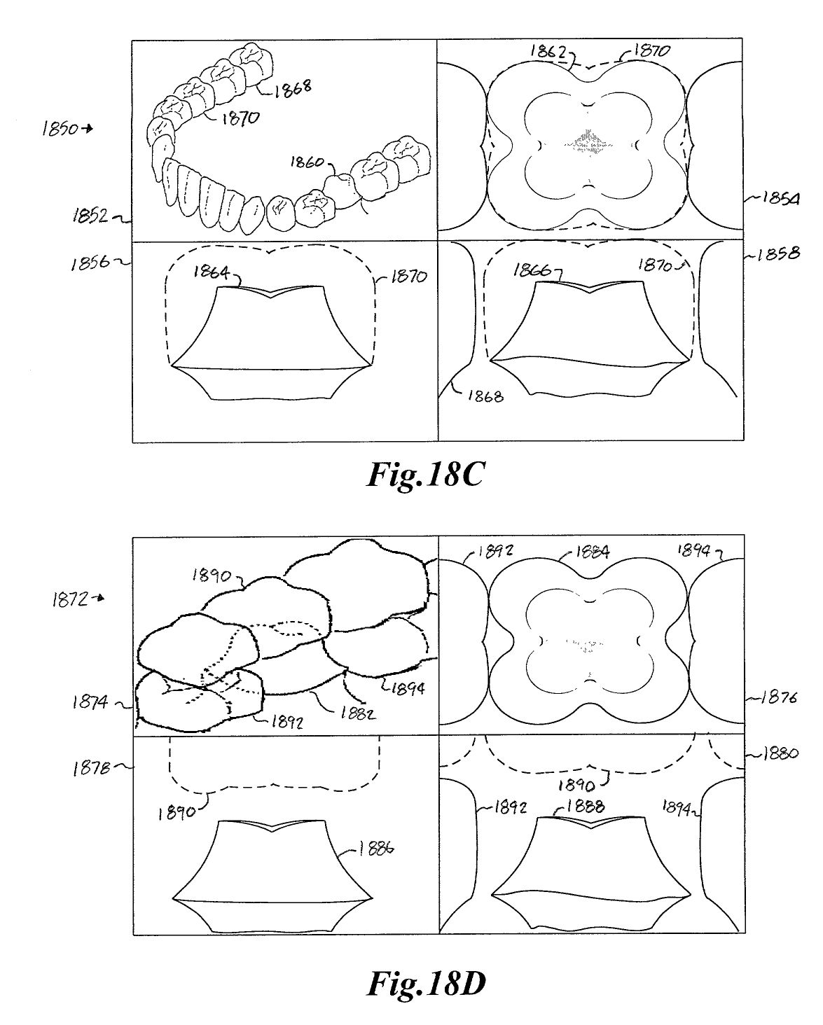

A computer display according to one embodiment of the present invention is shown in FIG. 18A and generally designated 1800. Computer display 1800 is divided into four quadrants 1802-1808, so as to allow the user to display a model of a dental preparation die from multiple vantage points. In the embodiment shown in FIG. 18A, computer display 1800 includes upper left quadrant 1802, upper right quadrant 1804, lower left quadrant 1806, and lower right quadrant 1808, each displaying the die model from one of several vantage points 1810-1816.

In the embodiment shown in FIG. 18A, upper left quadrant 1802 of computer display 1800 is displaying and isometric or three-quarters view 1810 of the die model. Upper right quadrant 1804 is displaying a top-down view 1812 of the same die model, while quadrants 1806 (lower left) and 1808 (lower right) are displaying front view 1814 and side view 1816, respectively. In alternate embodiments, the arrangement of the various views 1810-1816 may differ. For example, isometric view 1810 could be placed in a larger window 1802 than the principal axis views 1804-1808. In certain embodiments, the location, size, and orientation of windows 1802-1808 and views 1810-1816 may be fully adjustable by the user. For example, a user may desire to view the die model from four separate isometric views. In certain embodiments, additional windows and views may be created at the request of the user and customized as desired.

A computer display according to a second embodiment of the present invention is shown in FIG. 18B and generally designated 1820. Similarly to computer display 1800 described above, computer display 1820 is divided into four quadrants 1822-1828, so as to allow the user to display a model of a dental preparation die from multiple vantage points. In the embodiment shown in FIG. 18B, computer display 1820 includes upper left quadrant 1822, upper right quadrant 1824, lower left quadrant 1826, and lower right quadrant 1828, each displaying the die model from one of several vantage points 1830-1836.

In the embodiment shown in FIG. 18B, upper left quadrant 1822 of computer display 1820 is displaying and isometric or three-quarters view 1830 of the die model. Upper right quadrant 1824 is displaying a top-down view 1832 of the same die model, while quadrants 1826 (lower left) and 1828 (lower right) are displaying front view 1834 and side view 1836, respectively. In alternate embodiments, the arrangement of the various views 1830-1836 may differ. For example, isometric view 1830 could be placed in a larger window 1822 than the principal axis views 1824-1828. In certain embodiments, the location, size, and orientation of windows 1822-1828 and views 1830-1836 may be fully adjustable by the user. In certain embodiments, additional windows and views may be created at the request of the user and customized as desired.

In addition to the objects and views shown in computer display 1800 of FIG. 18A, computer display 1820 features additional objects not shown in computer display 1800. Whereas computer display 1800 featured views of only the die model in isolation, computer display 1820 displays digitized models of the patient's surrounding dentition, so as to further assist the user is selecting and shaping a crown suitable for the patient's mouth.

As seen in FIG. 18B, computer display 1820 shows adjacent teeth 1838 and 1840 in each of windows 1822-1828 in the correct position and orientation. Window 1822 shows adjacent teeth 1838 and 1840 as they appear in isometric view. In various embodiments, window 1822 may display these models in a hidden-line view as shown in FIG. 18B, or in any of the various manners in which three-dimensional geometries are commonly viewed. For example, window 1822 may in certain embodiments display view 1830 of the die model with hidden lines removed, or with opaque or translucent shading, as requirements or user preferences dictate.

Similarly to window 1822, windows 1824-1828 display the die model in place situated between adjacent teeth 1838 and 1840 as viewed along three principal orthogonal axes. Window 1824 shows teeth 1838 and 1840 as they appear viewed from above, while windows 1826 and 1828 display teeth 1838 and 1840 as they appear from the front and side of the patient's mouth, respectively. Along with the orthogonal display shown in window 1822, windows 1824-1828 assist the user in selecting and shaping a suitable dentition for the patient's mouth.

A computer display according to yet another embodiment of the present invention is shown in FIG. 18C and generally designated 1850. As described above in connection with computer displays 1800 and 1820, computer display 1850 is divided into four quadrants 1852-1858, so as to allow the user to display a model of a dental preparation die from multiple vantage points. In the embodiment shown in FIG. 18C, computer display 1850 includes upper left quadrant 1852, upper right quadrant 1854, lower left quadrant 1856, and lower right quadrant 1858, each displaying the die model from one of several vantage points 1860-1866.

In the embodiment shown in FIG. 18C, upper left quadrant 1852 of computer display 1850 is displaying an isometric or three-quarters view 1860 of the die model. Upper right quadrant 1854 is displaying a top-down view 1862 of the same die model, while quadrants 1856 (lower left) and 1858 (lower right) are displaying front view 1864 and side view 1866, respectively. In alternate embodiments, the arrangement of the various views 1860-1866 may differ. For example, isometric view 1860 could be placed in a larger window 1852 than the principal axis views 1854-1858. In certain embodiments, the location, size, and orientation of windows 1852-1858 and views 1860-1866 may be fully adjustable by the user.

Similarly to display 1820 of FIG. 18B, display 1850 is showing a digitized model 1868 of the patient's existing dentition to assist the user in selecting, sizing, and shaping an appropriate prosthetic. Of particular concern within dentition model 1868 is the digitized model 1870 of the tooth opposite the die model. The shape of model 1870 is helpful to the user in defining the overall contours and general shape of the patient's original tooth for which the prosthetic is being designed. In the embodiment shown in FIG. 18C, a “ghost” model of tooth model 1870 can be superimposed over views 1862-1866 of the die, to assist in shaping of the prosthetic. In certain embodiments, the “ghost” model 1870 may be an exact mirror image of the existing tooth and may be shown in an outline or half-shaded mode.

A computer display according to yet another embodiment of the present invention is shown in FIG. 18D and generally designated 1872. As described above in connection with computer displays 1800, 1820, and 1850, computer display 1872 is divided into four quadrants 1874-1880, so as to allow the user to display a model of a dental preparation die from multiple vantage points. In the embodiment shown in FIG. 18C, computer display 1872 includes upper left quadrant 1874, upper right quadrant 1876, lower left quadrant 1878, and lower right quadrant 1880, each displaying the die model from one of several vantage points 1882-1888.

In the embodiment shown in FIG. 18D, upper left quadrant 1874 of computer display 1872 is displaying an isometric or three-quarters view 1882 of the die model. Upper right quadrant 1876 is displaying a top-down view 1884 of the same die model, while quadrants 1878 (lower left) and 1880 (lower right) are displaying front view 1886 and side view 1888, respectively. In alternate embodiments, the arrangement of the various views 1874-1880 may differ. In certain embodiments, the location, size, and orientation of windows 1874-1880 and views 1882-1888 may be fully adjustable by the user. In certain embodiments, additional windows and views may be created at the request of the user and customized as desired.

Similarly to displays 1820 and 1850, display 1872 is showing a set of digitized models 1890-1894 of the patient's existing dentition to assist the user in selecting, sizing, and shaping an appropriate prosthetic. In this embodiment, model 1890 of the opposing tooth and models 1892 and 1894 of the adjacent teeth are shown to assist the user in selecting and shaping the prosthetic.

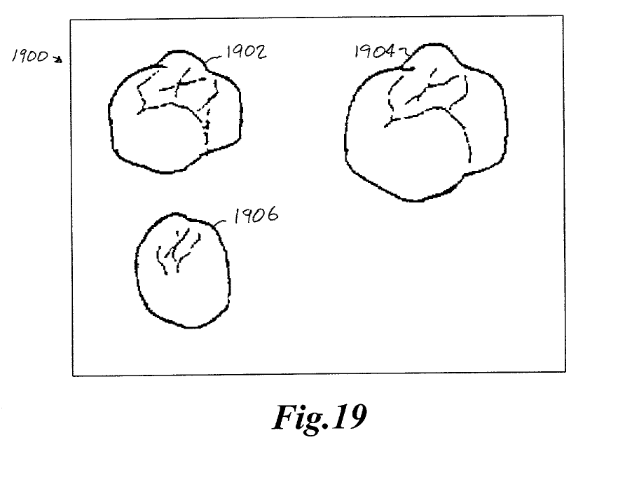

After the user has selected the initial orientations and angles from which he wishes to view the die model, the user can proceed to select a prosthetic model. One embodiment of a computer display suitable for selection of a prosthetic model is shown in FIG. 19 and generally designated 1900. As shown in FIG. 19, computer display 1900 is displaying prosthetic models 1902, 1904, and 1906 for comparison and selection by the user. In certain embodiments, prosthetic models can be stored in an electronic database including two or more types of prosthetics, including, for example, molars and incisors. Using computer display 1900, the user can select a prosthetic model that generally conforms to the shape of the surrounding teeth.

In certain embodiments, the computer software may incorporate search capability to enable the user to find the best prosthetic model quickly. In certain embodiments, the selection of the prosthetic shape may be performed partially or completely by a computer using some form of pattern-matching algorithm. For example, the computer software may incorporate contour analysis routines to generate a statistical profile of the desired tooth according to one or more geometric parameters. Such geometric parameters may include, but are not limited to: the aspect ratio of the surrounding teeth in one or more planes, the number of peaks and valleys along the top surface of the opposing teeth in one or more planes, and the ratio between the maximum and minimum dimensions of the surrounding and opposing teeth along one or more axes. Using this statistical profile, the computer software may then perform a search of the statistical profiles of the prosthetic tooth shapes in the database to generate a list of the closest matching shapes. In certain embodiments, the library of prosthetic shapes may incorporate a combination of basic geometric shapes and tooth models, which may include, for example, models of actual teeth, denture teeth, and theoretical tooth shapes.

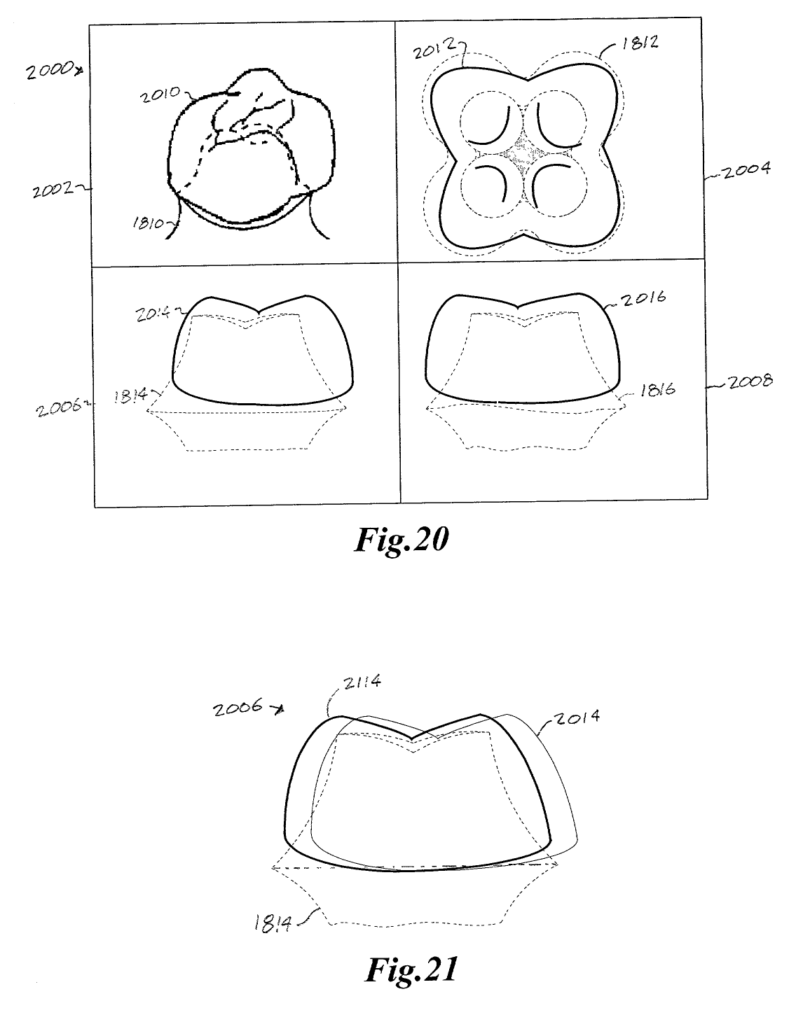

After the user has selected a prosthetic model, using either computer display 1900 or some other suitable device, certain embodiments of the prosthetic modeling software allow the user to customize the size and shape of the prosthetic as desired. One embodiment of a display screen useful for such customization is shown in FIG. 20 and generally designated 2000. Display screen 2000 is divided into four quadrants 2002-2008, each of which can display a separate view of the die and prosthetic models. The quadrants in display screen 2000 include upper left quadrant 2002, upper right quadrant 2004, lower left quadrant 2006, and lower right quadrant 2008.

In the embodiment shown in FIG. 20, each of the four quadrants 2002-2008 is being used to display the die and prosthetic from four distinct vantage points. Upper left quadrant 2002 is displaying an isometric view 2010 of the selected prosthetic superimposed on isometric view 1810 of the die model. At the same time, upper right quadrant 2004 is displaying a top view 2012 of the selected prosthetic superimposed on top view 1812 of the die model. Lower left quadrant 2006 is displaying a side view 2014 of the selected prosthetic superimposed on side view 1814. Lower right quadrant 2008 is displaying front view 2016 of the selected prosthetic superimposed on front view 1816. In certain embodiments, the location, size, and orientation of quadrants 2002-2008 and views 2010-2016 may be fully adjustable by the user. In certain embodiments, additional windows and views may be created at the request of the user and customized as desired.

Display screen 2000 can be used to align the selected prosthetic to the die model. A more detailed view of lower left quadrant 2006 is shown in FIG. 21. In this view, the selected prosthetic is shown in two positions 2014 and 2114. The position in view 2014 is the initial position of the prosthetic. The position in view 2114 is the position of the prosthetic after alignment with the die in view 1814 in the direction normal to the viewpoint. The alignment of the prosthetic in views 2000, 2004, and 2008 will work in a similar manner.

According to the present invention, a dial box, control panel, or pendant is generally used to manipulate the three-dimensional models for optimal effectiveness. In certain embodiments, the dial box is a separate, hand-held unit connected to the computer by cable such as a serial or USB cable. In certain embodiments, the dial box can be used for control of the window viewpoints, the prosthetic model location and orientation, and the geometric characteristics of the prosthetic model, including the scale and aspect ratio. In certain embodiments, the identical controls can be used for, each of these functions, depending on the mode in which the software is currently operating.

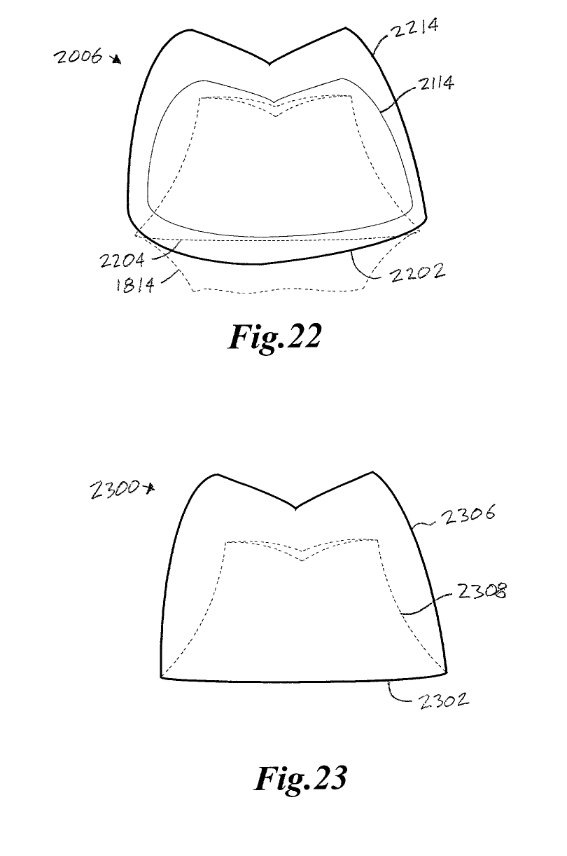

In addition to alignment of the die and prosthetic, display screen 2000 can be used to scale and shape the selected prosthetic to conform to the die model. Another detailed view of lower left quadrant 2006 is shown in FIG. 22. In this view, the selected prosthetic is shown in two sizes 2114 and 2214. The size in view 2114 is the initial size of the prosthetic. The size in view 2114 is the position of the prosthetic after scaling to conform to the die in view 1814. The scaling of the prosthetic in views 2000, 2004, and 2008 will work in a similar manner. After “morphing” of the prosthetic model, the lower edge 2202 of the prosthetic will meet with the die along preparation line 2004. Accordingly, in certain embodiments it is desirable that the lower edge 2202 be in the same vicinity as the preparation line 2204, so as to minimize distortion of the model during the morphing process. Certain embodiments may incorporate algorithms for minimizing this distortion.

After the prosthetic model is aligned, scaled, and otherwise preliminarily processed by the user, the prosthetic model is “morphed” by the computer software so that the inside and lower edge of the prosthetic model will conform to the upper surface and preparation line of the die model. A “morphed” prosthetic model is shown in FIG. 23 and generally designated 2300. Prosthetic model 2300 has a lower edge conforming to the preparation line 2204 of the die model, an inner surface 2308 conforming to the upper surface of the die model, and an outer surface inherited from the processed prosthetic model.

Once the initial design of the prosthetic is complete, it may be desirable to manipulate a portion of the prosthetic from its initial shape. In certain embodiments, the software may be set to display control points for the model surface curves in an area to be modified and the aforementioned dial box can be used to manipulate the curves in that area. This functionality would be useful, for example, in adjusting the height or shape of a cusp tip of the tooth, or for adjusting the curve of the tooth near the gum line for removing potential food traps.

The above method described is one manner of employing the novel teachings of the present invention, but numerous other methods could be employed without departing from the spirit and scope of the present invention. For example, in an alternate embodiment, the physical model of the mouth could be placed in the scanning apparatus with only the prepared die installed in the model. After digitization of the die, the die could be removed from the model and the adjacent teeth installed and digitized. With this method, two separate models are generated, one for the die and one for the adjacent teeth.

As another example, a bite registration plate could be placed over the adjacent teeth and digitized. As this bite registration plate contains a three-dimensional pattern of the opposing teeth in relationship to the adjacent teeth, the software would then have three-dimensional models of the die, the adjacent teeth, and the opposing teeth. Owing to the manner by which these models were captured, they would be in their correct three-dimensional relationship to one another.

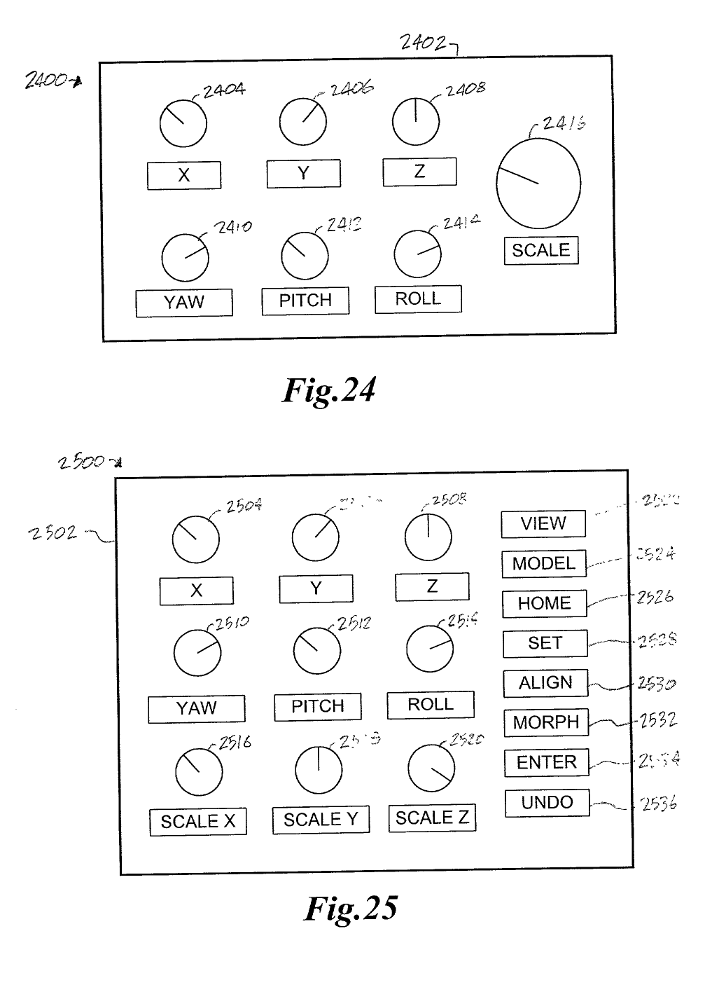

FIGS. 24 and 25 are views of two dial boxes, 2400 and 2500 respectively, useful with certain embodiments of the present invention. Dial boxes 2400 and 2500 contain control knobs for viewing, positioning, orienting, and scaling the die and prosthetic models.

Dial box 2400 incorporates dial box frame 2402, X control knob 2404, Y control knob 2406, and Z control knob 2408 for control of the viewing position and alignment of the die and prosthetic models. In addition, dial box 2400 incorporates YAW control knob 2410, PITCH control knob 2412, and ROLL control knob 2414 for viewing orientation and alignment of the die and prosthetic models. Dial box 2400 also incorporates SCALE control knob 2416 for adjustment of the scale of the die and prosthetic models. It will be understood by those of skill in the art that these controls are only illustrative of the types of controls that may be employed in conjunction with the present invention.

Dial box 2500, shown in FIG. 25, incorporates dial box frame 2502, X control knob 2504, Y control knob 2506, and Z control knob 2508 for control of the viewing position and alignment of the die and prosthetic models. In addition, dial box 2500 incorporates YAW control knob 2510, PITCH control knob 2512, and ROLL control knob 2514 for viewing orientation and alignment of the die and prosthetic models. Dial box 2500 incorporates SCALE X control knob 2516, SCALE Y control knob 2518, and SCALE Z control knob 2520 that can be used to control the scale of the die and prosthetic models along various axes. In certain embodiments, these knobs may scale the models along either global axes or local axes, as required.

Dial box 2500 incorporates a set of control buttons 2522-2536 to provide additional functionality and control of the three-dimensional models. These control buttons include a VIEW button 2522, a MODEL button 2524, a HOME button 2526, a SET button 2528, an ALIGN button 2530, a MORPH button 2532, an ENTER button 2534, and an UNDO button 2536. In certain embodiments, these buttons may have different functionalities depending on the functions the user is presently performing. For example, the ENTER button 2534 may not be ascribed any default functionality at all, but may be used to select objects, points, or features on the screen or to allow the user to respond to a query from the software.

The control knobs may also have varying functionality depending on context. For example, the X, Y, and Z control knobs 2504-2508 may be used at certain times to control an on-screen cursor, at other times to scroll or zoom the viewpoint, and at other times to adjust the position of an object on the screen. Again, it will be understood by those of skill in the art that the controls shown in FIG. 25 are only illustrative of the types of controls that may be employed in conjunction with the present invention.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of generating a dental prosthetic model comprising the steps of:
creating a three-dimensional computer model of a preparation die;
generating a three-dimensional computer model of a desired prosthetic shape;
orienting and positioning the three-dimensional computer model of the prosthetic with respect to the three-dimensional computer model of the preparation die using a control panel having one or more controls disposed therein;
processing the computer model of the desired prosthetic shape in such a manner that the internal surface of the prosthetic model conforms closely to the external surface of the preparation die.

2. The method of claim 1 further comprising the step of verifying the computer model of the preparation die.

3. The method of claim 2 wherein the step of verification comprises verification of a preparation line.

4. The method of claim 2 wherein the step of verification is performed using one or more closed-circuit cameras.

5. The method of claim 1 wherein the step of generating a three dimensional computer model of a desired prosthetic shape comprises selection of a standard prosthetic model from a library of models.

6. The method of claim 5 wherein the step of generating the three-dimensional computer model of the desired prosthetic shape further comprises modification of the contours of the standard model.

7. The method of claim 1 further comprising the step of modification of the geometric characteristics of the three-dimensional computer model of the desired prosthetic shape to fit closely to the geometric characteristics of the preparation die.

8. A method of generating a dental prosthetic model comprising the steps of:
creating a three-dimensional computer model of a preparation die;
selecting a three-dimensional computer model of a desired prosthetic shape from a library of standard shapes;
orienting and positioning the three-dimensional computer model of the desired prosthetic shape with respect to the three-dimensional computer model of the preparation die using a control panel having one or more controls disposed therein; and
sizing and shaping the three-dimensional computer model of the desired prosthetic shape to conform to the three-dimensional computer model of the dental preparation die using a control panel having one or more controls disposed therein.

9. The method of claim 8 further comprising the step of verifying the computer model of the preparation die.

10. The method of claim 9 wherein the step of verification comprises verification of a preparation line of the preparation die.

11. The method of claim 9 wherein the step of verification is performed using one or more closed-circuit cameras.

12. The method of claim 8 wherein the library of standard shapes includes basic geometric shapes and digital models of tooth shapes.

13. The method of claim 8 wherein the step of sizing and shaping the three-dimensional computer model of the prosthetic shape further comprises modification of the contours of the model.

14. The method of claim 8 wherein the step of sizing and shaping the three-dimensional computer model of the desired prosthetic shape is performed at least partly according to a computer algorithm.
